(19) United States
(12) Patent Application Publication
(10) Pub. No.: US 2026/0178772 A1
(43) Pub. Date: Jun. 25, 2026

(54) DE-IDENTIFICATION DEVICE AND METHOD

(71) Applicant: HTC Corporation, Taoyuan City (TW)

(72) Inventors: Hsin-Yu CHOU, Taoyuan City (TW); Chen-Han TSAI, Taoyuan City (TW); Yu-Shao PENG, Taoyuan City (TW)

(21) Appl. No.: 19/426,069

(22) Filed: Dec. 19, 2025

Related U.S. Application Data
(60) Provisional application No. 63/735,901, filed on Dec. 19, 2024.

(51) Int. Cl. G06F 21/62

(52) U.S. Cl. CPC G06F 21/6245

(57) ABSTRACT

A de-identification device and method are provided. The device stores a language model. The device generates multiple tokens corresponding to to-be-processed data using the language model. Based on a begin special tag and an end special tag, the device tags a target token among the tokens to generate a tagged data corresponding to the to-be-processed data, and the target token corresponds to a personal information. Based on the begin special tag and the end special tag in the tagged data, the device replaces the target token in the tagged data to generate de-identified data corresponding to the to-be-processed data.

### CROSS-REFERENCE TO RELATED APPLICATION

This application claims priority to U.S. Provisional Application Ser. No. 63/735,901, filed Dec. 19, 2024, which is herein incorporated by reference in its entirety.

### BACKGROUND

### Field of Invention

The present disclosure relates to a de-identification device and method. More particularly, the present disclosure relates to a de-identification device and method that can correctly perform de-identification operations based on a language model.

### Description of Related Art

Text de-identification is crucial for protecting sensitive personal information. By removing or anonymizing identifiers, it can prevent unauthorized disclosure of personal data, enabling organizations to securely use textual data for research, analysis, and development. Furthermore, de-identification is particularly important in the medical field, as access to patient information can drive significant advancements, but must be handled with care to protect privacy.

In existing technologies, traditional text de-identification methods include Named Entity Recognition (NER) models and rule-based systems. In traditional de-identification algorithms, the de-identification model simply classifies each input token in a given medical text as either sensitive personal information or non-sensitive information. The token marked as “sensitive” is removed, while the rest of the medical text remains unchanged. However, named entity recognition models require a large amount of labeled training data to perform binary classification of the tags representing the text.

Furthermore, these methods rely on predefined patterns and supervised learning methods. While these methods are effective in controlled environments, their scalability and adaptability are often insufficient in various real-world environments.

In contrast, Large Language Models (LLMs) are a powerful foundational tool capable of handling most Natural Language Processing (NLP) tasks. For input text (e.g., a prompt), a large language model produces a series of tokens as output.

However, a key challenge faced by large language models is the hallucination problem, where language models produce meaningless or inaccurate content (e.g., content not present in the original data). In de-identification in the medical field, the hallucination problem includes rewriting and truncation, which can lead to the loss or inaccuracy of medical information.

Accordingly, there is an urgent need for a de-identification technology that can correctly perform de-identification operations based on language models.

### SUMMARY

An objective of the present disclosure is to provide a de-identification device. The de-identification device comprises a storage, a transceiver interface, and a processor. The processor generates a plurality of tokens corresponding to to-be-processed data by the language model. The processor tags a target token among the plurality of tokens based on a begin special tag and an end special tag by the language model to generate tagged data corresponding to the to-be-processed data, wherein the target token corresponds to personal information. The processor replaces the target token in the tagged data based on the begin special tag and the end special tag in the tagged data to generate de-identified data corresponding to the to-be-processed data.

Another objective of the present disclosure is to provide a de-identification method, which is adapted for use in an electronic device. The electronic device stores a language model. The de-identification method comprises the following steps: generating, by the language model, a plurality of tokens corresponding to to-be-processed data; tagging, by the language model, a target token among the plurality of tokens based on a begin special tag and an end special tag to generate tagged data corresponding to the to-be-processed data, wherein the target token corresponds to personal information; and replacing the target token in the tagged data based on the begin special tag and the end special tag in the tagged data to generate de-identified data corresponding to the to-be-processed data.

According to the above descriptions, the de-identification technology provided by the present disclosure (at least including the device and the method) can actively tag the target token in the tokens of the to-be-processed data based on special tags, thereby generating tagged data corresponding to the to-be-processed data. Furthermore, the de-identification technology disclosed herein uses positional information provided by special tags in the tagged data to replace the target token in the tagged data, thereby generating de-identified data corresponding to the to-be-processed data. Since the de-identification technology disclosed herein can employ a trained language model, it can make more accurate predictions based on context and other information when performing word prediction. In addition, the de-identification technology disclosed herein can be fine-tuned to be applicable to various domains, providing scalability and adaptability. Furthermore, under strict conditions and candidate token constraints, the de-identification technology disclosed herein allows the language model to make accurate predictions and eliminates the risks of hallucination, paraphrasing, or truncation (i.e., the de-identified data will not contain tokens that do not belong to the original data content), thereby improving the reliability and accuracy of the de-identification output. Therefore, the de-identification technology disclosed herein can ensure the accuracy of the de-identified data ultimately provided to users, thus solving the problems of existing technologies.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view depicting a de-identification device of some embodiments;

FIG. 2 is a schematic view depicting a prompt template of some embodiments;

FIG. 3 is a schematic view depicting a token representation of the to-be-processed data of some embodiments;

FIG. 4 is a schematic view depicting a tagging operation of some embodiments;

FIG. 5A is a schematic view depicting an example of the to-be-processed data of some embodiments;

FIG. 5B is a schematic view depicting an example of tagged data of some embodiments;

FIG. 5C is a schematic view depicting an example of tagged data of some embodiments; and

FIG. 6 is a partial flowchart depicting a de-identification method of the second embodiment.

### DETAILED DESCRIPTION

In the following description, a de-identification device and method according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

The problem that the present disclosure aims to solve is briefly described. The de-identification algorithm disclosed herein aims to detect and remove personal information from highly sensitive text files (e.g., medical reports) and generate de-identified data for the corresponding highly sensitive text files.

The present disclosure provides a de-identification algorithm based on structural decoding of a language model (e.g., a large language model LLM). Accordingly, this disclosure utilizes the extensive knowledge of a trained language model and selects target token through the tagging constraints and candidate token generation methods provided in this disclosure, thereby eliminating the hallucination problem that may occur in large language models LLM.

The application scenarios of this disclosure include setting/executing the de-identification device and method in an external system (e.g., a cloud server) or integrating them into a user device (e.g., a computer, a mobile phone). This disclosure can generate tagged data based on the operation of various different tagging stages, and replace the target token (e.g., sensitive data containing personal information) in the tagged data.

Furthermore, in subsequent applications, the de-identification device/method disclosed herein can output the generated de-identified data to the user device in a suitable form (e.g., marked with different color levels) to provide the user with additional information.

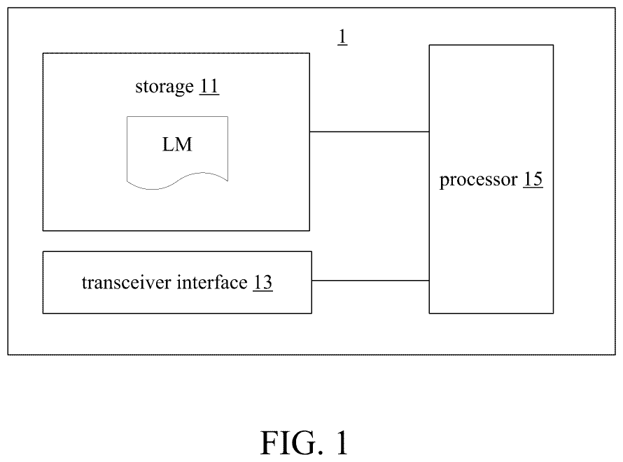

The first embodiment of the present disclosure is a de-identification device 1, the structure of which is schematically depicted in FIG. 1. In this embodiment, the de-identification device 1 comprises a storage 11, a transceiver interface 13, and a processor 15. The processor 15 is electrically connected to the storage 11 and the transceiver interface 13. In some embodiments, the transceiver interface 13 is communicatively connected to a storage device (e.g., a database server) to obtain the to-be-processed data.

It shall be appreciated that the storage 11 may be a memory, a Universal Serial Bus (USB) disk, a hard disk, a Compact Disk (CD), a mobile disk, or any other storage medium or circuit known to those of ordinary skill in the art and having the same functionality. The transceiver interface 13 is an interface capable of receiving and transmitting data or other interfaces capable of receiving and transmitting data and known to those of ordinary skill in the art. The transceiver interface 13 can receive data from sources such as external devices, external web pages, external applications, and so on. The processor 15 may be any of various processors, Central Processing Units (CPUs), microprocessors, digital signal processors or other computing devices known to those of ordinary skill in the art.

In the present embodiment, as shown in FIG. 1, the storage 11 can store the language model LM. Specifically, the language model LM is a large language model that has been trained. The language model LM can be used to generate de-identified data based on user input (e.g., to-be-processed data) and user prompts.

In some embodiments, the language model LM can be fine-tuned using historical training data (e.g., multiple historical to-be-processed data and multiple historical de-identified data).

It shall be appreciated that when the de-identification device 1 disclosed herein is in operation, it can control the language model LM to generate de-identified data corresponding to the to-be-processed data by inputting prompts and the to-be-processed data into the language model LM under the constraints set in this disclosure.

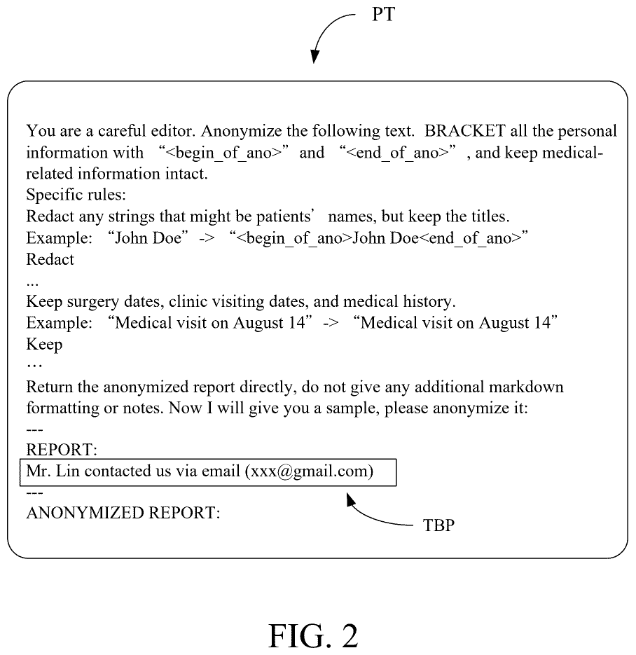

For ease of understanding, please refer to the prompt template PT in FIG. 2. In the present example, the PT template specifies that all personal information should be enclosed in brackets using a begin special tag (i.e., <begin_of_ano>) and an end special tag (i.e., <end_of_ano>), while retaining medical-related information.

Furthermore, in this example, the prompt template PT specifies that the language model LM redacts all strings that could represent the patient's name, but retains the title. For example, the data string “John Doe” should be tagged as “<begin_of_ano>John Doe<end_of_ano>”.

Furthermore, in this example, the prompt template PT specifies that the language model LM retains the surgery date, clinic visiting date, and medical history. For example, because the term “Medical visit” does not contain sensitive personal information, the data string “Medical visit on August 14” should remain “Medical visit on August 14” after it is tagged.

Furthermore, in this example, the prompt template PT specifies that the language model LM should directly return anonymized reports (i.e., de-identified data) without adding any additional formatting (e.g., Markdown format) or notes. Additionally, the prompt template PT may provide at least one example (e.g., the to-be-processed data TBP) to allow the language model LM to learn and perform de-identification processing. In some embodiments, multiple historical de-identification examples can be provided to the language model LM for fine-tuning to improve the accuracy of de-identification.

For ease of explanation, the figures in this disclosure are all illustrated using English sources. It shall be appreciated that the figures in this disclosure are merely illustrative and do not limit the languages used/recognized by the de-identification device 1 and the language model LM. Those skilled in the art to which this disclosure pertains should be able to understand, based on the content provided in this disclosure, the implementation of the de-identification device 1 in other languages (e.g., Chinese, English, etc.).

Next, the following paragraphs will explain in detail the specific operation of the de-identification device 1 in this disclosure.

First, in the present embodiment, the de-identification device 1 can obtain the to-be-processed data (TBP) (e.g., sensitive data that needs to be de-identified) from the storage 11 or an external device. Next, a plurality of tokens corresponding to the to-be-processed data TBP are generated by the trained language model LM.

It shall be appreciated that a token in a language model LM can represent a segment of text, which could be a word, a sub-word, or even a single character. The language model LM generates text by predicting one token at each time-step based on the preceding tokens (e.g., predicting the probability of occurrence). In some embodiments, the tokens can be generated sequentially during the operation of the language model LM, or generated all at once after analysis by the language model LM.

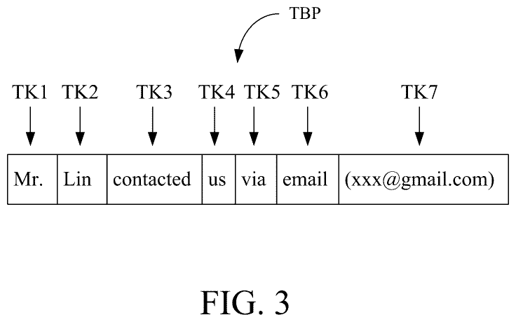

For ease of understanding, please refer to the token diagram of the to-be-processed data in FIG. 3. In this example, the Language Model LM can generate tokens in a corresponding order based on the to-be-processed data TBP, such as: the token TK1 “Mr.”, the token TK2 “Lin”, the token TK3 “contacted”, the token TK4 “us”, the token TK5 “via” the token TK6 “email”, and the token TK7 “(xxx@gmail.com)”.

Next, in the present embodiment, the processor 15 uses the special tags defined in this disclosure to allow the language model LM to tag the content in the to-be-processed data TBP, so as to accurately generate tagged data. Specifically, the processor 15 uses the language model LM to tag a target token among the plurality of tokens based on a begin special tag and an end special tag to generate tagged data corresponding to the to-be-processed data TBP, and the target token corresponds to personal information (i.e., sensitive personal information).

In some embodiments, the target token being tagged should be enclosed by the begin special tag and the end special tag, and framed in the order of the begin special tag first and the end special tag last. Specifically, the tagging data comprises a tagging order of the begin special tag, the target token, and the end special tag.

In some embodiments, the tokens generated by the language model LM may be sub-word tokens. Since sub-word tokens themselves do not carry word meaning, individual judgments will affect the correctness of de-identification.

Therefore, in order to improve the accuracy of the tokens, the processor 15 can pre-determine whether the currently processed token is meaningful at each tagging phase. If the currently processed token is determined by processor 15 to be a meaningless sub-word token, the sub-word token will be merged with the next token, and the above operation will continue until the currently processed token is determined to be a meaningful token.

Specifically, the processor 15 determines whether a currently processed token is a meaningful token. Then, in response to the current processed token not being a meaningful token, the processor 15 forms a new current processed token based on the current processed token and a next processed token.

For example, take the token TK3 “contacted” in FIG. 3 as an example. In this example, when generating tokens, the language model LM divides the token “contacted” into the token “conta” and the token “cted”.

In this example, when the language model LM is currently processing the token “conta”, but the language model LM determines that the token “conta” itself does not have word meaning, the language model LM merges the currently processed token “conta” with the token “cted” in the next segment to produce the token “contacted”, which is used as the currently processed token. If the merged token still does not have meaning, the merging operation continues.

In some embodiments, the processor 15 generates corresponding candidate token for selection based on the order in which tokens appear in the original data at different phases/conditions. It shall be appreciated that this disclosure actively restricts the candidate token corresponding to each phase to only include tokens that originally appeared in the to-be-processed data TBP and special tag (i.e., the begin special tag and the end special tag). Therefore, tokens that do not belong to the to-be-processed data TBP will not appear, thus avoiding the hallucination problem generated by the language model LM.

Specifically, the processor 15 generates a candidate token corresponding to each of a plurality of tagging phases based on an appearing order of the plurality of tokens in the to-be-processed data TBP. Next, the processor 15 selects a target candidate token from each of the plurality of tagging phases. Finally, the processor 15 tags the target token among the plurality of tokens based on the begin special tag and the end special tag in the target candidate tokens.

It shall be appreciated that the tagging technology provided in this disclosure can select different mechanisms to generate the candidate token under different conditions (i.e., the occurrence of the begin special tag and the end special tag).

It shall be appreciated that the first tagging phase, the second tagging phase, the third tagging phase, and the fourth tagging phase mentioned in this disclosure are merely illustrative examples of conditions and do not have a sequential relationship. Those skilled in the art to which this disclosure pertains should be able to understand the implementation of the de-identification device 1 in different conditions/phases based on the content provided in this disclosure.

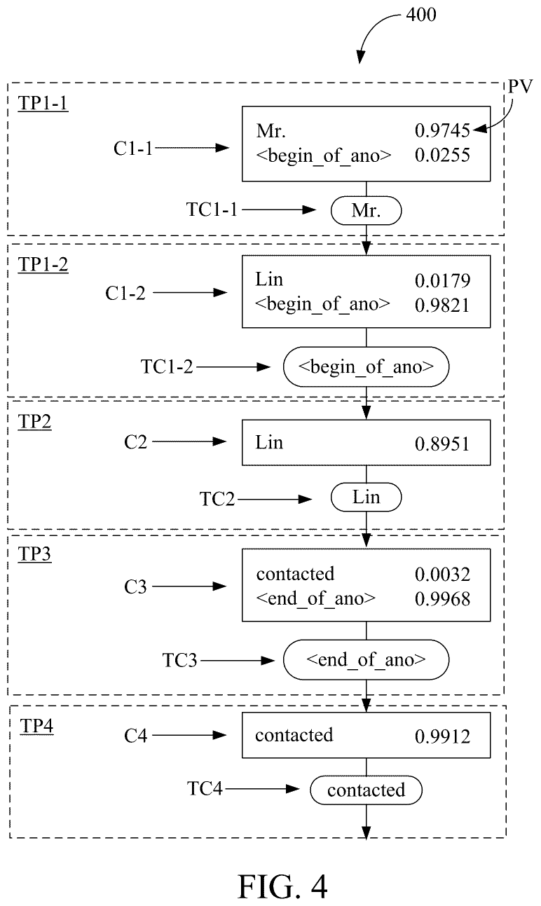

The following will detail the specific details of generating the candidate token corresponding to each of the multiple tagging phases under different conditions. For ease of understanding, please refer to the tagging operation diagram 400 in FIG. 4, taking the to-be-processed data TBP in FIG. 3 as an example (i.e., “Mr. Lin contacted us via email (xxx@gmail.com)”).

The generation process of the first token is shown in the tagging phase TP1-1 of this example. In the first time step, the candidate token C1-1 generated by the language model LM contains two tokens: the original token “Mr.” and the token “<begin_of_ano>” (i.e., the begin special tag).

If the language model LM does not detect any personal information in the first token, the original token “Mr.” should be selected. Conversely, if the language model LM detects personal information in the first token, the token “<begin_of_ano>” should be selected to tag the beginning position of the sensitive text.

In this example, since the language model LM did not detect any personal information in the original token “Mr.”, the token “Mr.” was selected as the target candidate token “TC1-1”.

In some embodiments, the language model LM can generate a probability value PV (e.g., confidence level) for each token in the corresponding candidate token C1-1. In some embodiments, the language model LM prioritizes the token with high probability values PV as the target candidate token.

Next, the generation process of the second token is shown in the second tagging phase TP1-2 of this example. In the second time step, the previous token is “Mr.”, and the candidate token C1-2 generated by the language model LM contains two tokens: the original token “Lin” and the token “<begin_of_ano>”.

In this example, the key to the language model LM's decision lies in whether the current token represents personal information. Since the token “Lin” is a name, the language model LM determines that it belongs to personal information. Therefore, the language model LM should select the token “<begin_of_ano>” to tag the beginning of the sensitive text sequence. In other words, the language model LM selects the token “<begin_of_ano>” as the target candidate token TC1-2.

Specifically, in a first tagging phase (e.g., the tagging phase TP1-1 and the tagging phase TP1-2), the language model LM determines whether the target candidate token of a previous tagging phase of the first tagging phase is the begin special tag or the end special tag. Then, in response to the target candidate token in the previous tagging phase not being the begin special tag or the end special tag, the language model LM generates the candidate token of the first tagging phase based on an original token and the begin special tag.

Next, the generation process of the third token is shown in the tagging phase TP2 of this example. In the third time step, since the previous token is “<begin_of_ano>”, the candidate token C2 generated by the language model LM is restricted to the original token “Lin”. This is because the previously selected token is “<begin_of_ano>” (i.e., it has entered the position of tagging sensitive text). The language model LM selects the token “Lin” as the target candidate token TC2.

Specifically, in a second tagging phase (e.g., the tagging phase TP2), the language model LM determines whether the target candidate token of a previous tagging phase of the second tagging phase is the begin special tag. Then, in response to the target candidate token of the previous tagging phase being the begin special tag, the language model LM generates the candidate token of the second tagging phase based on an original token.

Next, the generation process of the fourth token is shown in the tagging phase TP3 of this example. In the fourth time step, the candidate token C3 generated by the language model LM is limited to the token “end_of_ano” (i.e., the ending tag) and the original token “contacted”. In this example, since the token “contacted” is not personal information, the language model LM should select the token “<end_of_ano>” to end the current de-identified text scope. In other words, the language model LM selects the token “<end_of_ano>” as the target candidate token TC3.

Specifically, in a third tagging phase (e.g., the tagging phase TP3), the language model LM determines whether the target candidate token of a previous tagging phase of the third tagging phase is the begin special tag or the end special tag. Then, the language model LM determines whether the tagging phases preceding the third tagging phase have an unfinished begin special tag. Next, in response to the target candidate token of the previous tagging phase not being the begin special tag or the end special tag and the tagging phases preceding the third tagging phase having the unfinished begin special tag, the language model LM generates the candidate token of the third tagging phase based on an original token and the end special tag.

Next, in the tagging phase TP4 of this example, the generation process of the fifth token is shown. In the fifth time step, since the previous token is “<end_of_ano>”, the candidate token C4 generated by the language model LM is restricted to the original token “contacted”.

In this example, to ensure that consecutive segments of personal information are framed by a pair of tokens “<begin_of_ano>” and “<end_of_ano>”, the language model LM restricts the token selection to only selecting the original token if either “<begin_of_ano>” or “<end_of_ano>” was selected in the previous time step. In other words, the language model LM selects the token “contacted” as the target candidate token TC4.

Specifically, in a fourth tagging phase (e.g., the tagging phase TP4), the language model LM determines whether the target candidate token of a previous tagging phase of the fourth tagging phase is the end special tag. Then, in response to the target candidate token of the previous tagging phase being the end special tag, the language model LM generates the candidate token of the fourth tagging phase based on an original token.

Next, the remaining tokens will continue to operate in the aforementioned judgment method until all tokens of the to-be-processed data TBP to be processed have been tagged.

Finally, in the present embodiment, the processor 15 replaces the target token with the information provided by the special tag to generate de-identified data. Specifically, the processor 15 replaces the target token in the tagged data based on the begin special tag and the end special tag in the tagged data to generate de-identified data corresponding to the to-be-processed data TBP.

It shall be appreciated that although the foregoing example only illustrates the identification/replacement of one target token, those skilled in the art to which this disclosure pertains should be able to understand the implementation of the de-identification device 1 for multiple target tokens based on the content provided in this disclosure.

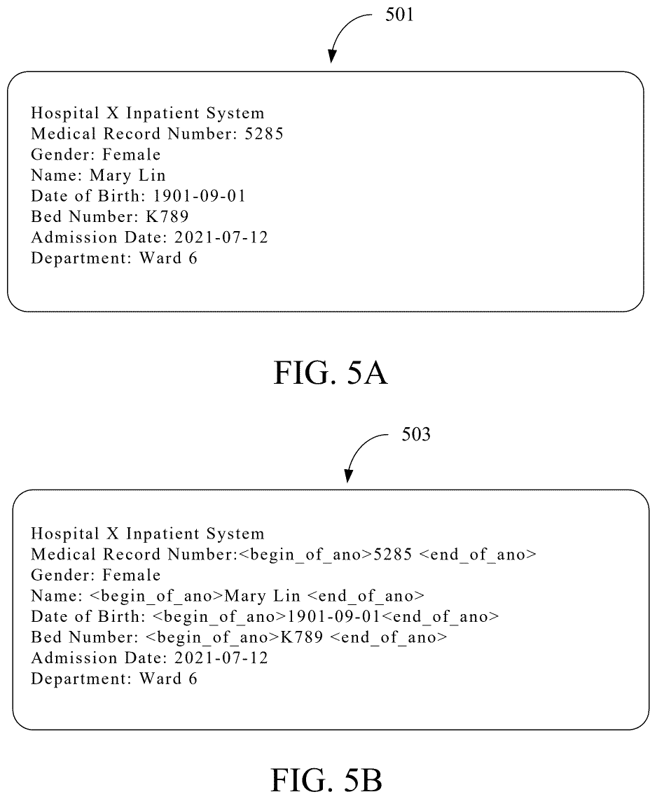

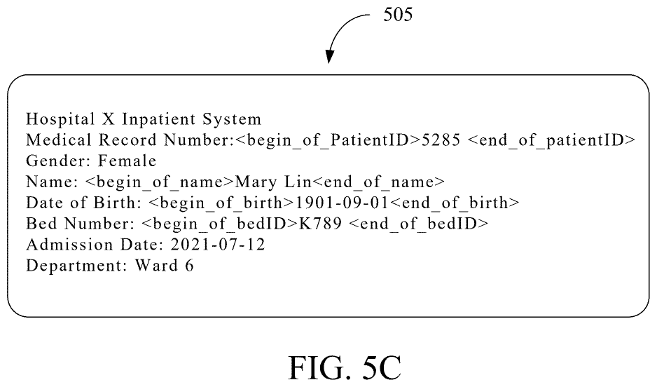

For ease of understanding, please refer to FIG. 5A and FIG. 5B. Schematic diagram 501 in FIG. 5A illustrates the to-be-processed data TBP. In this example, the to-be-processed data TBP is medical data, which includes information such as “Hospital X Inpatient System”, “Medical Record Number: 5285”, “Gender: Female”, “Name: Mary Lin”, “Date of Birth: 1901-09-01”, “Bed Number: K789”, “Admission Date: 2021-07-12”, “Department: Ward 6”, etc.

Furthermore, schematic diagram 503 of FIG. 5B illustrates a type of tagging data. In this example, the de-identification device 1 generates tagging data corresponding to the to-be-processed data TBP. The tagged data includes tagging content such as “Medical Record Number: <begin_of_ano>5285<end_of_ano>”, “Name: <begin_of_ano>Mary Lin <end_of_ano>”, “Date of Birth: <begin_of_ano>1901-09-01<end_of_ano>”, and “Bed Number: <begin_of_ano>K789<end_of_ano>”.

For example, the processor 15 may use other alternative words (e.g., words that do not pose a risk to personal privacy) to replace/hide these token tagged by the specially tags.

In some embodiments, the begin special tag and the end special tag further correspond to a classification tag (e.g., patient identification number, patient name, date of birth, bed number, etc.). Specifically, processor 15 generates a replacement token corresponding to the classification tag. Then, based on the replacement token, processor 15 replaces the target token in the tagged data to generate the de-identified data corresponding to the to-be-processed data TBP.

For example, schematic diagram 505 of FIG. 5C illustrates a type of tagged data. In this example, the tagged data includes tagged content such as “Medical Record Number: <begin_of_PatientID>5285<end_of_PatientID>”, “Name: <begin_of_name>Mary Lin <end_of_name>”, “Date of Birth: <begin_of_birth>1901-09-01<end_of_birth>”, “Bed Number: <begin_of_bedID>K789<end_of_bedID>”, etc.

In this example, the processor 15 can replace the target token in the tagged data with a preset replacement token corresponding to the category, thereby replacing sensitive data with the correct category replacement token. For example, patient identification numbers are replaced with “1234”, and patient names are replaced with “Sam”.

In some embodiments, the processor 15 may generate a replacement token corresponding to a color tag based on confidence value (e.g., the probability value PV) of the target token. Then, the processor 15 may replace the target token in the tagged data based on the replacement token of the color tag to generate the de-identified data corresponding to the to-be-processed data TBP.

For example, target tokens with higher confidence values are represented by red replacement tokens, and target tokens with lower confidence values are represented by green replacement tokens. In this example, the de-identification device 1 can generate/output visual results so that users can determine the content of the de-identified data through the visual display.

According to the above descriptions, the de-identification device 1 provided by the present disclosure can actively tag the target token in the tokens of the to-be-processed data based on special tags, thereby generating tagged data corresponding to the to-be-processed data. Furthermore, the de-identification device 1 disclosed herein uses positional information provided by special tags in the tagged data to replace the target token in the tagged data, thereby generating de-identified data corresponding to the to-be-processed data. Since the de-identification device 1 disclosed herein can employ a trained language model, it can make more accurate predictions based on context and other information when performing word prediction. In addition, the de-identification device 1 disclosed herein can be fine-tuned to be applicable to various domains, providing scalability and adaptability. Furthermore, under strict conditions and candidate token constraints, the de-identification device 1 disclosed herein allows the language model to make accurate predictions and eliminates the risks of hallucination, paraphrasing, or truncation (i.e., the de-identified data will not contain tokens that do not belong to the original data content), thereby improving the reliability and accuracy of the de-identification output. Therefore, the de-identification device 1 disclosed herein can ensure the accuracy of the de-identified data ultimately provided to users, thus solving the problems of existing technologies.

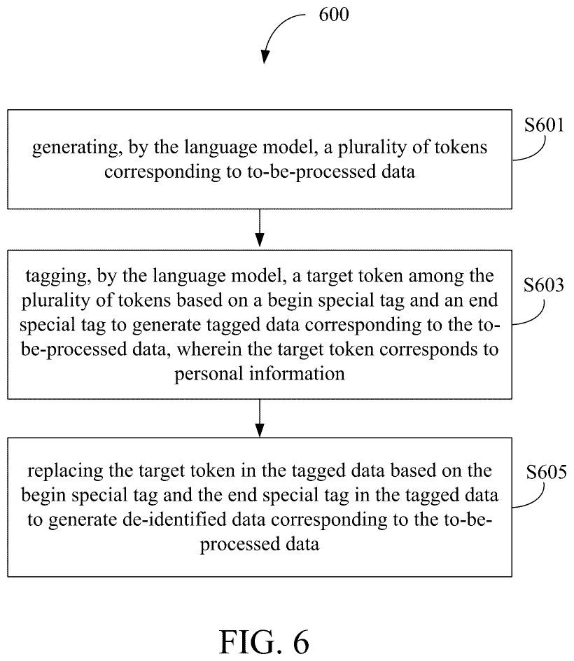

A second embodiment of the present invention is a de-identification method and a flowchart thereof is depicted in FIG. 6. The de-identification method 600 is adapted for use in an electronic device (e.g., the de-identification device 1 of the first embodiment). The electronic device stores a language model (e.g., the language model LM of the first embodiment). The de-identification method 600 generates de-identified data corresponding to the to-be-processed data through the steps S601 to S605.

First, in the step S601, the language model generates a plurality of tokens corresponding to to-be-processed data.

Next, in the step S603, the language model tags a target token among the plurality of tokens based on a begin special tag and an end special tag to generate tagged data corresponding to the to-be-processed data, wherein the target token corresponds to personal information.

Finally, in the step S605, the electronic device replaces the target token in the tagged data based on the begin special tag and the end special tag in the tagged data to generate de-identified data corresponding to the to-be-processed data.

In some embodiments, the tagged data comprises a tagging order of the begin special tag, the target token, and the end special tag.

In some embodiments, the step of tagging the target token among the plurality of tokens further comprises the following steps: determining whether a currently processed token is a meaningful token; and in response to the current processed token not being a meaningful token, forming a new current processed token based on the current processed token and a next processed token.

In some embodiments, the begin special tag and the end special tag further correspond to a classification tag, and the step of replacing the target token in the tagged data comprises the following steps: generating a replacement token corresponding to the classification tag; and replacing the target token in the tagged data based on the replacement token to generate the de-identified data corresponding to the to-be-processed data.

In some embodiments, the step of tagging the target token among the plurality of tokens comprises the following steps: generating a candidate token corresponding to each of a plurality of tagging phases based on an appearing order of the plurality of tokens in the to-be-processed data; selecting a target candidate token from each of the plurality of tagging phases; and tagging the target token among the plurality of tokens based on the begin special tag and the end special tag in the target candidate tokens.

In some embodiments, the step of generating the candidate token corresponding to each of the plurality of tagging phases comprises the following steps: determining, in a first tagging phase, whether the target candidate token of a previous tagging phase of the first tagging phase is the begin special tag or the end special tag; and in response to the target candidate token in the previous tagging phase not being the begin special tag or the end special tag, generating the candidate token of the first tagging phase based on an original token and the begin special tag.

In some embodiments, the step of generating the candidate token corresponding to each of the plurality of tagging phases comprises the following steps: determining, in a second tagging phase, whether the target candidate token of a previous tagging phase of the second tagging phase is the begin special tag; and in response to the target candidate token of the previous tagging phase being the begin special tag, generating the candidate token of the second tagging phase based on an original token.

In some embodiments, the step of generating the candidate token corresponding to each of the plurality of tagging phases comprises the following steps: determining, in a third tagging phase, whether the target candidate token of a previous tagging phase of the third tagging phase is the begin special tag or the end special tag; determining whether the tagging phases preceding the third tagging phase have an unfinished begin special tag; and in response to the target candidate token of the previous tagging phase not being the begin special tag or the end special tag and the tagging phases preceding the third tagging phase having the unfinished begin special tag, generating the candidate token of the third tagging phase based on an original token and the end special tag.

In some embodiments, the step of generating the candidate token corresponding to each of the plurality of tagging phases comprises the following steps: determining, in a fourth tagging phase, whether the target candidate token of a previous tagging phase of the fourth tagging phase is the end special tag; and in response to the target candidate token of the previous tagging phase being the end special tag, generating the candidate token of the fourth tagging phase based on an original token.

In some embodiments, the de-identification method 600 further comprises the following steps: generating a replacement token corresponding to a color tag based on confidence value of the target token; and replacing the target token in the tagged data based on the replacement token of the color tag to generate the de-identified data corresponding to the to-be-processed data.

In addition to the aforesaid steps, the second embodiment can also execute all the operations and steps of the de-identification device 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

It shall be appreciated that in the specification and the claims of the present invention, some words (e.g., the tagging phase) are preceded by terms such as “first”, “second”, “third”, or “fourth”, and these terms of “first”, “second”, “third”, or “fourth” are only used to distinguish these different words. For example, the “first” and “second” in the first tagging phase and the second tagging phase are only used to indicate the different tagging phase.

According to the above descriptions, the de-identification technology provided by the present disclosure (at least including the device and the method) can actively tag the target token in the tokens of the to-be-processed data based on special tags, thereby generating tagged data corresponding to the to-be-processed data. Furthermore, the de-identification technology disclosed herein uses positional information provided by special tags in the tagged data to replace the target token in the tagged data, thereby generating de-identified data corresponding to the to-be-processed data. Since the de-identification technology disclosed herein can employ a trained language model, it can make more accurate predictions based on context and other information when performing word prediction. In addition, the de-identification technology disclosed herein can be fine-tuned to be applicable to various domains, providing scalability and adaptability. Furthermore, under strict conditions and candidate token constraints, the de-identification technology disclosed herein allows the language model to make accurate predictions and eliminates the risks of hallucination, paraphrasing, or truncation (i.e., the de-identified data will not contain tokens that do not belong to the original data content), thereby improving the reliability and accuracy of the de-identification output. Therefore, the de-identification technology disclosed herein can ensure the accuracy of the de-identified data ultimately provided to users, thus solving the problems of existing technologies.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A de-identification device, comprising:
a storage, storing a language model;
a transceiver interface; and
a processor, being electrically connected to the storage and the transceiver interface, and being configured to perform operations comprising:
generating, by the language model, a plurality of tokens corresponding to to-be-processed data;
tagging, by the language model, a target token among the plurality of tokens based on a begin special tag and an end special tag to generate tagged data corresponding to the to-be-processed data, wherein the target token corresponds to personal information; and
replacing the target token in the tagged data based on the begin special tag and the end special tag in the tagged data to generate de-identified data corresponding to the to-be-processed data.

2. The de-identification device of claim 1, wherein the tagged data comprises a tagging order of the begin special tag, the target token, and the end special tag.

3. The de-identification device of claim 1, wherein the operation of tagging the target token among the plurality of tokens further comprises the following operations:
determining whether a currently processed token is a meaningful token; and
in response to the current processed token not being a meaningful token, forming a new current processed token based on the current processed token and a next processed token.

4. The de-identification device of claim 1, wherein the begin special tag and the end special tag further correspond to a classification tag, and the operation of replacing the target token in the tagged data comprises the following operations:
generating a replacement token corresponding to the classification tag; and
replacing the target token in the tagged data based on the replacement token to generate the de-identified data corresponding to the to-be-processed data.

5. The de-identification device of claim 1, wherein the operation of tagging the target token among the plurality of tokens comprises the following operations:
generating a candidate token corresponding to each of a plurality of tagging phases based on an appearing order of the plurality of tokens in the to-be-processed data;
selecting a target candidate token from each of the plurality of tagging phases; and
tagging the target token among the plurality of tokens based on the begin special tag and the end special tag in the target candidate tokens.

6. The de-identification device of claim 5, wherein the operation of generating the candidate token corresponding to each of the plurality of tagging phases comprises the following operations:
determining, in a first tagging phase, whether the target candidate token of a previous tagging phase of the first tagging phase is the begin special tag or the end special tag; and
in response to the target candidate token in the previous tagging phase not being the begin special tag or the end special tag, generating the candidate token of the first tagging phase based on an original token and the begin special tag.

7. The de-identification device of claim 5, wherein the operation of generating the candidate token corresponding to each of the plurality of tagging phases comprises the following operations:
determining, in a second tagging phase, whether the target candidate token of a previous tagging phase of the second tagging phase is the begin special tag; and
in response to the target candidate token of the previous tagging phase being the begin special tag, generating the candidate token of the second tagging phase based on an original token.

8. The de-identification device of claim 5, wherein the operation of generating the candidate token corresponding to each of the plurality of tagging phases comprises the following operations:
determining, in a third tagging phase, whether the target candidate token of a previous tagging phase of the third tagging phase is the begin special tag or the end special tag;
determining whether the tagging phases preceding the third tagging phase have an unfinished begin special tag; and
in response to the target candidate token of the previous tagging phase not being the begin special tag or the end special tag and the tagging phases preceding the third tagging phase having the unfinished begin special tag, generating the candidate token of the third tagging phase based on an original token and the end special tag.

9. The de-identification device of claim 5, wherein the operation of generating the candidate token corresponding to each of the plurality of tagging phases comprises the following operations:
determining, in a fourth tagging phase, whether the target candidate token of a previous tagging phase of the fourth tagging phase is the end special tag; and
in response to the target candidate token of the previous tagging phase being the end special tag, generating the candidate token of the fourth tagging phase based on an original token.

10. The de-identification device of claim 1, wherein the processor further performs the following operations:
generating a replacement token corresponding to a color tag based on confidence value of the target token; and
replacing the target token in the tagged data based on the replacement token of the color tag to generate the de-identified data corresponding to the to-be-processed data.

11. A de-identification method, being adapted for use in an electronic device, wherein the electronic device stores a language model, and the de-identification method comprises the following steps:
generating, by the language model, a plurality of tokens corresponding to to-be-processed data;
tagging, by the language model, a target token among the plurality of tokens based on a begin special tag and an end special tag to generate tagged data corresponding to the to-be-processed data, wherein the target token corresponds to personal information; and
replacing the target token in the tagged data based on the begin special tag and the end special tag in the tagged data to generate de-identified data corresponding to the to-be-processed data.

12. The de-identification method of claim 11, wherein the tagged data comprises a tagging order of the begin special tag, the target token, and the end special tag.

13. The de-identification method of claim 11, wherein the step of tagging the target token among the plurality of tokens further comprises the following steps:
determining whether a currently processed token is a meaningful token; and
in response to the current processed token not being a meaningful token, forming a new current processed token based on the current processed token and a next processed token.

14. The de-identification method of claim 11, wherein the begin special tag and the end special tag further correspond to a classification tag, and the step of replacing the target token in the tagged data comprises the following steps:
generating a replacement token corresponding to the classification tag; and
replacing the target token in the tagged data based on the replacement token to generate the de-identified data corresponding to the to-be-processed data.

15. The de-identification method of claim 11, wherein the step of tagging the target token among the plurality of tokens comprises the following steps:
generating a candidate token corresponding to each of a plurality of tagging phases based on an appearing order of the plurality of tokens in the to-be-processed data;
selecting a target candidate token from each of the plurality of tagging phases; and
tagging the target token among the plurality of tokens based on the begin special tag and the end special tag in the target candidate tokens.

16. The de-identification method of claim 15, wherein the step of generating the candidate token corresponding to each of the plurality of tagging phases comprises the following steps:
determining, in a first tagging phase, whether the target candidate token of a previous tagging phase of the first tagging phase is the begin special tag or the end special tag; and
in response to the target candidate token in the previous tagging phase not being the begin special tag or the end special tag, generating the candidate token of the first tagging phase based on an original token and the begin special tag.

17. The de-identification method of claim 15, wherein the step of generating the candidate token corresponding to each of the plurality of tagging phases comprises the following steps:
determining, in a second tagging phase, whether the target candidate token of a previous tagging phase of the second tagging phase is the begin special tag; and
in response to the target candidate token of the previous tagging phase being the begin special tag, generating the candidate token of the second tagging phase based on an original token.

18. The de-identification method of claim 15, wherein the step of generating the candidate token corresponding to each of the plurality of tagging phases comprises the following steps:
determining, in a third tagging phase, whether the target candidate token of a previous tagging phase of the third tagging phase is the begin special tag or the end special tag;
determining whether the tagging phases preceding the third tagging phase have an unfinished begin special tag; and
in response to the target candidate token of the previous tagging phase not being the begin special tag or the end special tag and the tagging phases preceding the third tagging phase having the unfinished begin special tag, generating the candidate token of the third tagging phase based on an original token and the end special tag.

19. The de-identification method of claim 15, wherein the step of generating the candidate token corresponding to each of the plurality of tagging phases comprises the following steps:
determining, in a fourth tagging phase, whether the target candidate token of a previous tagging phase of the fourth tagging phase is the end special tag; and
in response to the target candidate token of the previous tagging phase being the end special tag, generating the candidate token of the fourth tagging phase based on an original token.

20. The de-identification method of claim 11, wherein the de-identification method further comprises the following steps:
generating a replacement token corresponding to a color tag based on confidence value of the target token; and
replacing the target token in the tagged data based on the replacement token of the color tag to generate the de-identified data corresponding to the to-be-processed data.
